(19) United States
(12) Patent Application Publication
(10) Pub. No.: US 2014/0076121 A1
(43) Pub. Date: Mar. 20, 2014

(54) Hybrid Drum Shell

(71) Applicant: Christopher A. Carr, Perkasie, PA (US)

(72) Inventor: Christopher A. Carr, Perkasie, PA (US)

(21) Appl. No.: 13/975,341

(22) Filed: Aug. 25, 2013

Related U.S. Application Data
(60) Provisional application No. 61/703,500, filed on Sep. 20, 2012.

(51) Int. Cl. G10D 13/02

(52) U.S. Cl. CPC G10D 13/028
USPC 84/411 R; 29/896.22

(57) ABSTRACT

A hybrid drum shell includes a drum shell made from at least one first species of wood. A plurality of drum shell supplements made from at least one second species of wood are affixed to an interior side of the drum shell. The drum shell supplements substantially conform to the curvature of the interior of the drum shell and are interconnected such that the drum shell supplements substantially cover the interior side of the drum shell.

### CROSS REFERENCE TO RELATED APPLICATION

This application claims the benefit of U.S. Provisional Patent Application No. 61/703,500, filed Sep. 20, 2012, and entitled Hybrid Drum Shell, the entire disclosure of which is incorporated herein by reference.

### COPYRIGHT NOTICE AND AUTHORIZATION

Portions of the documentation in this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

Drums and the making of drums are generally known in the art. Drums come in a variety of types, shapes, sizes and are made out of a variety of materials. For example, a non-exhaustive list of common drum types includes snare drums, bass drums, tom-tom drums, steel drums, bongo drums and conga drums.

When constructing a drum, there is generally a selection between expensive, specialized drum shells (e.g., solid wood drum shells, stave drum shells and steam bent shells) that generally maintain a wide variety of wood choices and superior tonal quality, and mass-produced, relatively inexpensive ply drum shells, which generally lack wood selection and tonal quality of the other drum shell types.

### BRIEF DESCRIPTION OF THE DRAWINGS

The following detailed description will be better understood when read in conjunction with the appended drawings, in which there is shown one or more of the multiple embodiments of the present disclosure. It should be understood, however, that the various embodiments of the present disclosure are not limited to the precise arrangements and instrumentalities shown in the drawings.

In the Drawings:

FIG. 1 is a front elevated view of one embodiment of a snare drum in accordance with the present disclosure;

FIG. 2 is a bottom view of the drum of FIG. 1;

FIG. 3 is a bottom view of a drum including a hybrid drum shell in accordance with one embodiment of the present disclosure;

FIG. 4 is an elevated view of a drum shell supplement in accordance with the drum of FIG. 3;

FIG. 5 is an elevated side perspective view of the drum shell supplement of FIG. 4;

FIG. 6 is an elevated top view of a drum shell in accordance with the drum of FIG. 3;

FIG. 7 is an elevated view of the drum shell supplement clamped to the drum shell of FIG. 3;

FIG. 8 is a side view of the drum shell supplement clamped to the drum shell of FIG. 3;

FIG. 9 is an elevated view of a completed hybrid drum shell in accordance with one embodiment of the present disclosure;

FIG. 10 is an elevated view of one embodiment of a snare drum using the hybrid drum shell of FIG. 9;

FIG. 11 is close-up view of the hybrid drum shell of FIG. 3;

FIG. 12 is an end view of a bass drum that includes a hybrid drum shell in accordance with the present disclosure;

FIG. 13 is an elevated view of a tom-tom drum that includes a hybrid drum shell in accordance with the present disclosure;

FIG. 14 is a close-up view of multiple drum shell supplements in accordance with the present disclosure; and

FIG. 15 is a close-up view of a hybrid drum shell using multiple reinforcement rings in accordance with the present disclosure.

### DETAILED DESCRIPTION

Certain terminology is used herein for convenience only and is not to be taken as a limitation on the embodiments of the present disclosure. In the drawings, the same reference letters are employed for designating the same elements throughout the several figures.

The words “right”, “left”, “lower” and “upper” designate directions in the drawings to which reference is made. The words “inwardly” and “outwardly” refer to directions toward and away from, respectively, the geometric center of the drum and/or drum shell and designated parts thereof. The terminology includes the words above specifically mentioned, derivatives thereof and words of similar import.

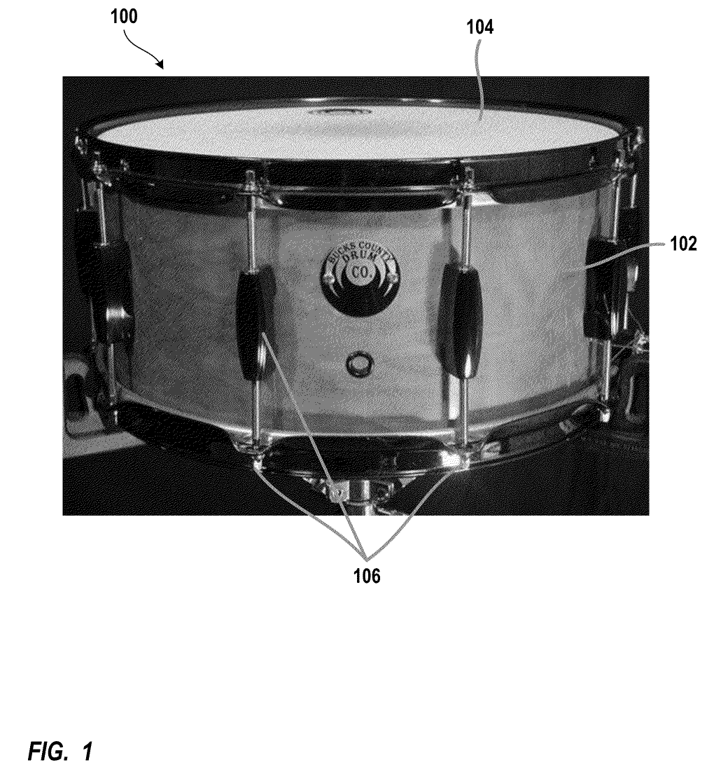

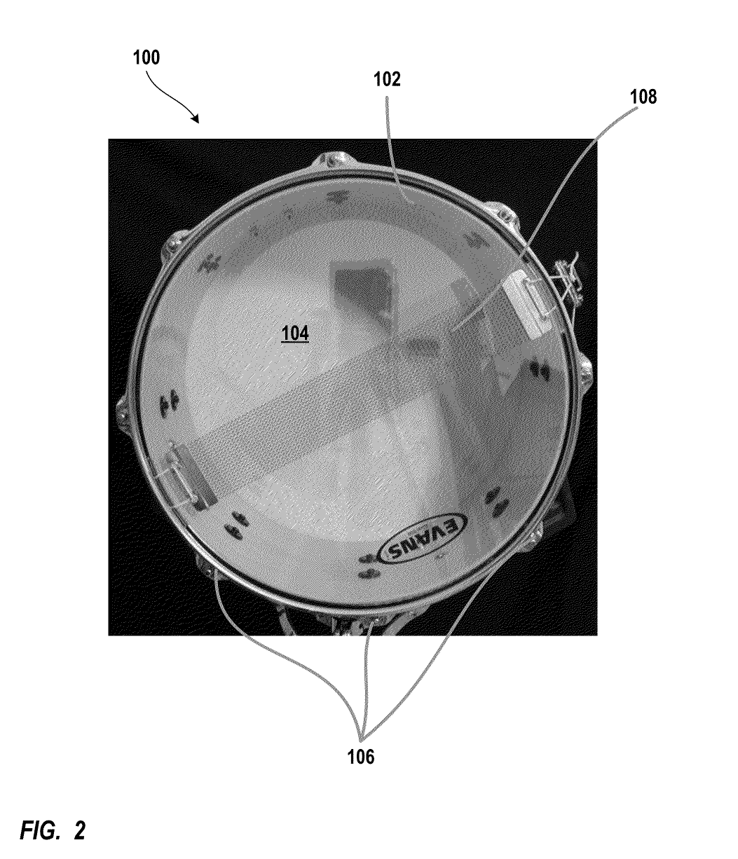

Referring to FIGS. 1 and 2, a snare drum 100 is formed by an open-ended, generally cylindrical drum shell 102 (or drum body), a first drum head 104, and a second drum head (not shown) attached to and covering opposite ends of the drum shell 102. The first and second drum heads are attached to the drum shell 102 using hardware 106. One of ordinary skill in the art would understand that a variety of different types of drum shells, drum heads and hardware could be used in the construction and assembly of the drum 100. Several bore holes (not shown) through the sides of the drum shell 102 may be used to attach the hardware 106 to the drum 100 and drum shell 102. A snare 108 (see FIG. 2) may be stretched across the inner side of the second drum head and attached to either side of the drum shell 102 and may secured to the drum 100 using the hardware 106.

The drum shell 102 may be made from a variety of materials, structures and processes. In one embodiment, the drum shell 102 is made from wood. A non-exhaustive list of woods commonly used in drum shell construction includes maple, birch, beech, poplar, ash and mahogany. An exhaustive list is omitted here for convenience only, and should not be considered limiting. In another embodiment, the drum shell is made from plywood or a similar manufactured or non-uniform wood material. The drum shell 102 may also be made from other materials, including metal, bamboo or plastic. The type of material and method of construction of the drum shell 102 affects the quality and timbre of the sound of the drum 100 when struck. For example, when constructed from wood, harder or denser species of wood generally create more even tones. Additionally, the direction of the grain of the wood used to construct the drum shell 102 often affects the tone of the drum, with a vertical grain typically being more desirable.

The drum shell 102 may be constructed using a variety of different methodologies. In one embodiment, the drum shell 102 is constructed from a solid piece of wood. In this embodiment, a solid piece of wood, such as a tree trunk, is hollowed out and sculpted, carved, and/or sanded into the desired shape, thereby requiring no joints or glue in forming the shell. Solid wood drum shells, while maintaining excellent tone, are expensive. In another embodiment, the drum shell is a stave drum shell, constructed using wood that is cut into several small pieces with beveled edges (i.e., staves) arranged to form the cylindrical shape of the drum shell 102. The staves may be glued and clamped together to form the shell. After drying, the stave drum shell may be lathed to create an even, uniform cylindrical body. A stave drum shell generally maintains much of the tone from the wood and may maintain the desired grain, but is still nonetheless costly, may be prone to shrinking over time (affecting the tone of the drum) and has a relatively specialized construction process. In another embodiment, the drum shell 102 may be made from a single piece of wood cut into a long, relatively thin section and exposed to steam to add enough moisture to the wood to allow it to be bent and formed into a cylinder. The two opposite ends of the bent section may then be affixed to each other with glue. While maintaining a good tone, the steam bending methodology requires a horizontal grain, has a limited shell thickness and is generally difficult to implement. In yet another embodiment, the drum shell 102 is formed in a plywood fashion, using thin sheets of wood (i.e., plies) that are glued together (back-to-back) and placed into a mold, where pressure is applied. This process may be automated and generally uses less expensive wood than the other drum shell embodiments. Thus, while ply drum shells are generally more economical to construct, they have a limited wood selection and generally lack the clear tone of the other drum shell embodiments.

In FIG. 2, a bottom view of the snare drum 100 is shown with the second drum head removed, thus showing the inner side of the first drum head 104. The cavity formed and bounded by the inner portion of the drum shell 102 and the inner sides of the drum heads may also be referred to as a “resonate chamber.” Variations on the parts, assembly and construction of the drum 100 will vary depending on the specific type of drum desired, materials used, desired sound and other factors generally known to those skilled in the art. More specifically, other embodiments and types of drums comprising a generally cylindrical drum shell, one or more drum heads and hardware to attach the drum heads to the shell will be readily recognized by those skilled in the art, including snare drums, bass drums, tom-tom drums, steel drums, bongo drums and conga drums. A detailed description of drum construction and/or the numerous variations of the types of drums and constructions methodologies are not included here for convenience only and should not be considered limiting.

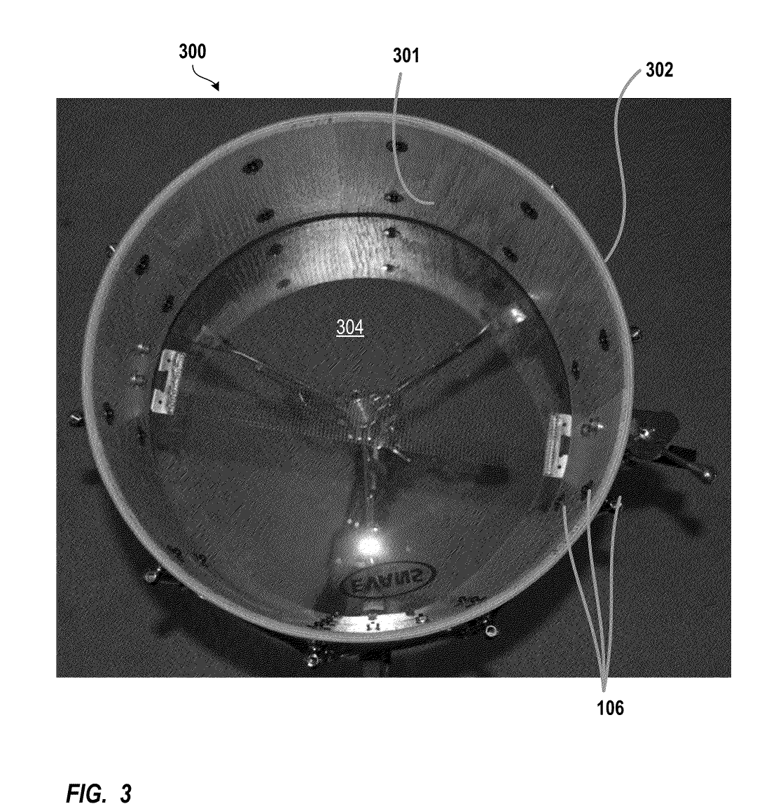

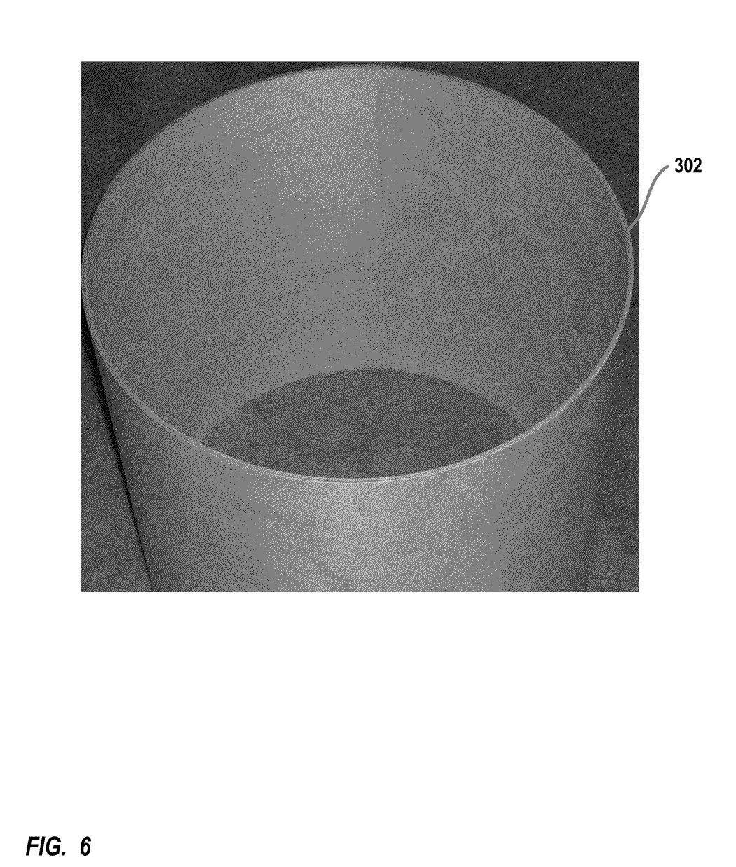

Referring generally to FIGS. 3-11, a drum 300 including a hybrid drum shell 301 in accordance with one embodiment of the present disclosure is shown. The hybrid drum shell 301 forms the generally cylindrical body of the drum 300 (and thus the resonant chamber of the drum 300) in a similar manner as described above with respect to the drum shell 102 and the drum 100. The hybrid drum shell 301 generally comprises a drum shell 302 having several relatively thin, drum shell supplements 310 (described in greater detail below), interconnected to each other and affixed to the inner side of the drum shell 302. The drum shell 302 may be any drum shell generally known in the art as described above with respect to the drum shell 102 of FIGS. 1-2. For example, the drum shell 302 may be a ply drum shell, a solid wood drum shell, a stave drum shell or a steam bent drum shell. For example, as shown in FIG. 6, in one embodiment, the drum shell 302 may be a ply drum shell because it is generally the least expensive type with a poor quality tonal sound, thereby resulting in significant gains in tonal quality from the presently disclosed system and method. In alternate embodiments, however, the drum shell 302 may be formed from other types of drum shell construction in order to change, improve or repair the tonal quality and the aesthetic look of the hybrid drum shell 301 and/or the drum 300.

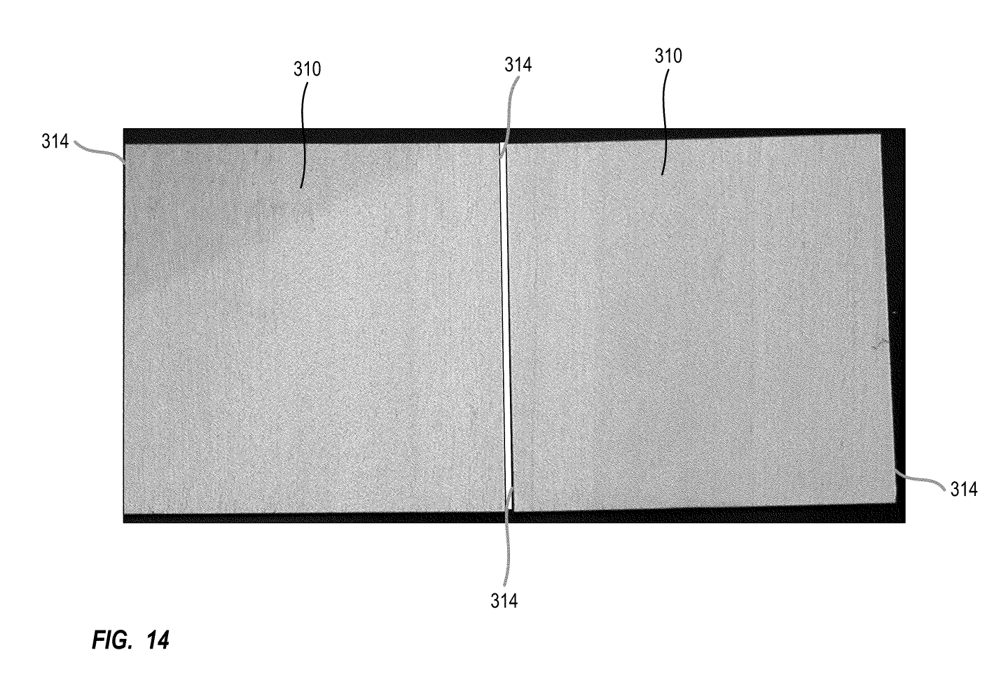

As shown in FIG. 14, in one embodiment the drum shell supplements 310 include lateral straight edges 314 configured to abut the edge(s) of one or more adjacent drum shell supplements 310 when affixed to the inner side of the drum shell 302. That is, FIG. 14 shows multiple drum shell supplements 310 placed adjacent to each other prior to being affixed to the drum shell 302. Alternatively, the drum shell supplements 310 may have one or more angled or beveled lateral edges (not shown) to facilitate interconnection to the adjacent drum shell supplements 310. In alternate embodiments, a notch or other type of wood joint may be used to interconnect the drum shell supplements 310. Regardless of the type of joint or edge used, the individual drum shell supplements may be configured to fit together such that there is little, substantially no, or no gap between the individual supplements 310 when assembled.

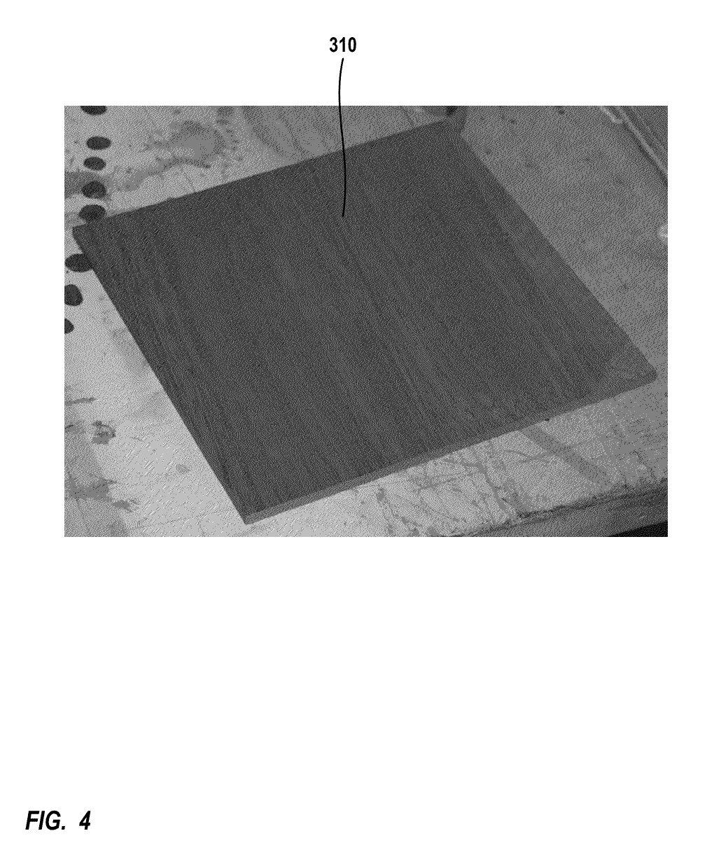

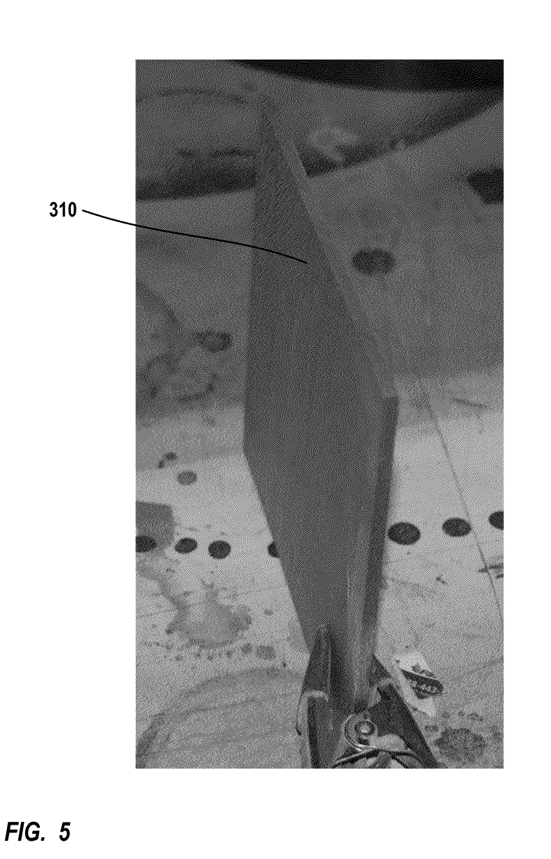

The drum shell supplements 310 (see e.g., FIGS. 4 and 5) may be any of a variety of species of wood, thickness, length and width, and/or shape depending on the desired tonal qualities and/or appearance of the drum 300 or hybrid drum shell 301 when assembled. For example, the drum shell supplements 310 may be made of oak, maple, birch, beech, poplar, ash, mahogany, rosewood, bamboo, or any other wood generally applicable in drum-making In one embodiment, the supplements 310 are solid pieces of the chosen wood, such that both sides of the drum shell supplements 310 reflect the material and quality of the selected wood. In an alternate embodiment, other non-wood materials may be substituted for wood in forming the drum shell supplements 310, such as metal (e.g., aluminum). In one embodiment, the drum shell supplements 310 are generally rectangular pieces of wood having a length and width that are each greater than their thickness (depth).

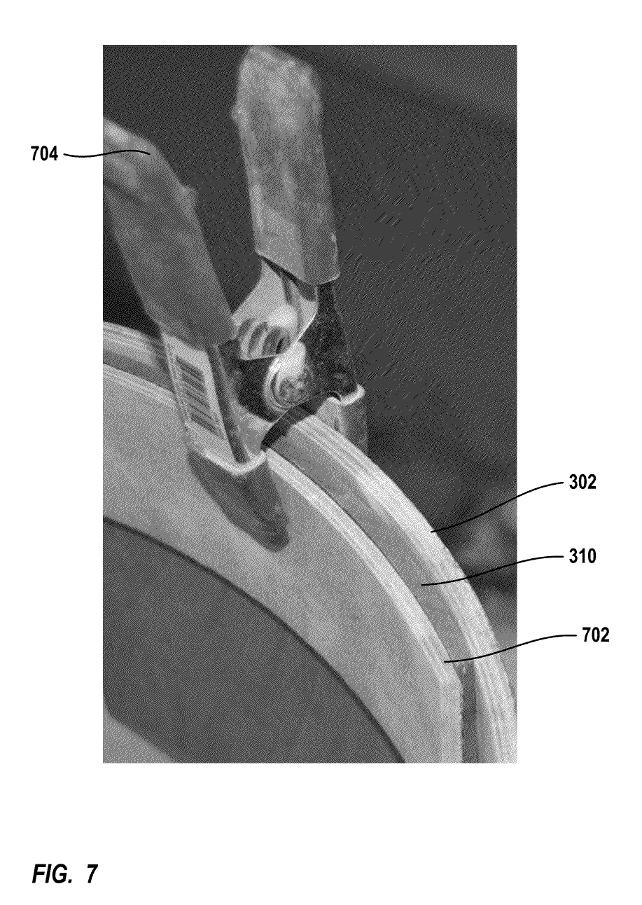

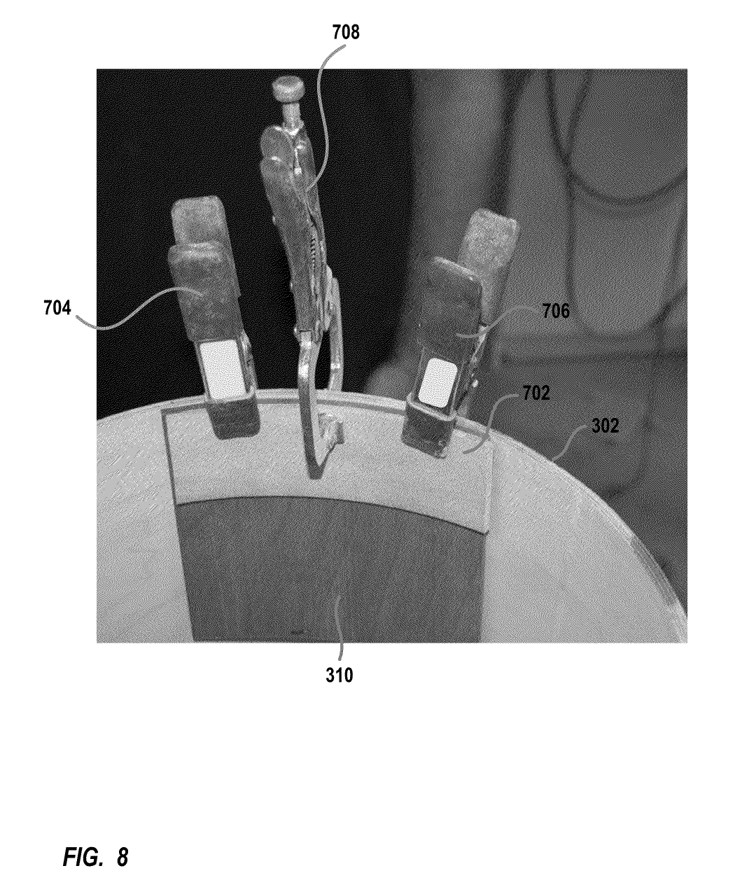

Referring to FIGS. 7 and 8, the drum shell supplements 310 may be secured against the drum shell 302 using a curved clamping block 702 held in place with a clamp 704. The curved clamping block 702 may have the same curvature as the inside of the drum shell 302, and may be made of a variety of materials and produced in a variety of manners generally known in the art. The clamp 704 may be any clamping device capable of holding the drum shell supplements 310 together against the interior side of the drum shell 302 while causing the drum shell supplements 310 to be bent to the curvature of the curved clamping block 702 and thus the drum shell 302. In one embodiment, one or more additional curved clamping blocks 702 (not shown) and clamps 704 (not shown) may be used to secure the other portions (e.g., lower) of the drum shell supplements 310 against the drum shell 302, thereby causing the drum shell supplements 310 to more evenly match the curvature of the drum shell 302 over the entirety of the portion of the drum shell 302 to which the supplement 310 is affixed. Alternatively, a single clamping block 702 that is substantially the same height as the drum shell 302 and drum shell supplement 310 may be used thus providing uniform pressure across the entire drum shell supplement 310. Alternatively, the drum shell supplements 310 are bent to the desired curvature prior to attachment to the inner side of the drum shell 302.

After the drum shell supplements 310 have been bent to the curvature of drum shell 302, the drum shell supplements 310 may be affixed or adhered to the drum shell 302 using any adhesive or other attachment method generally known in the art. The drum shell supplements 310 may be affixed, for example, with carpenter's glue, yellow glue or polyurethane glue. In one embodiment, the now-bent drum shell supplement 310 is temporarily removed from the clamp 704 and adhesive is spread evenly on the inner side of the drum shell 302. Once adhesive has been applied to the drum shell 302 and/or the exterior side of the drum shell supplement 310, the drum shell supplement 310 may be pressed against the portion of the drum shell 302 with the adhesive (see FIG. 8). The curved clamping block 702 may be replaced over the drum shell supplement 310 in a manner similar to that described above. In addition, clamps 704, 706, 708 may be placed in a manner to hold the drum shell 302, the drum shell supplement 310 and the curved clamping block 702 together until the adhesive dries. In one embodiment, an additional curved clamping block 702 (not shown) is applied to other portions of the drum shell supplement 310 to help it adhere to the drum shell 302 more evenly. Alternatively, a single clamping block 702 that is substantially the same height as the drum shell 302 and the drum shell supplement 310 may be used thus providing uniform pressure across the entire drum shell supplement 310.

The process of adhering the drum shell supplements 310 to the drum shell 302 described with respect to FIGS. 7 and 8 is repeated around the interior of the drum shell 302 until the entire interior of the drum shell 302 is covered in drum shell supplements 310 thereby forming the hybrid drum shell 301. It should be understood that the drum shell supplements 310 may all be bent before adhering any single drum shell supplement 310 to the drum shell 302. Alternatively, the drum shell supplements 310 may be individually bent and then adhered to the drum shell 302. In one embodiment, the drum shell supplements 310 are of uniform shape, size and thickness. Alternatively, the individual supplements 310 are of differing dimensions.

When adhering additional drum shell supplements 310 if one or more other drum shell supplements 310 have already been adhered to the drum shell 302, the drum shell supplements 310 may be pressed together laterally or diagonally (or otherwise according to the seam of the individual wood pieces 310) to ensure a tight bond between each of the individual drum shell supplements 310. After the entire interior of the drum shell 302 has one or more drum shell supplements 310 attached thereto, a woodworking sealer or a comparable substance known in the art may be applied to the drum shell supplements 310. Additional sanding, trimming or rounding of the top and bottom edges where the drum shell 302 and the drum shell supplements 310 meet may be necessary.

A first drum head 304 (the inner side of which is shown in FIG. 3) is attached to the hybrid drum shell 301 using hardware 106 in a manner similar to that as described with respect to the snare drum 100 in FIGS. 1-2. Thus, the resonant chamber of the drum 300 is thus bounded by the inner side of the interconnecting drum shell supplements 310, instead of the material of the drum shell 302, such that the drum 300 constructed from the hybrid drum shell 301 has a tonal quality that relates to the drum shell supplements 310. This construction positively affects the sound of the drum 300 by making it more resonant, giving it more projection volume and yielding a deeper sound by introducing more wood, and less glue to the interior of the resonant chamber.

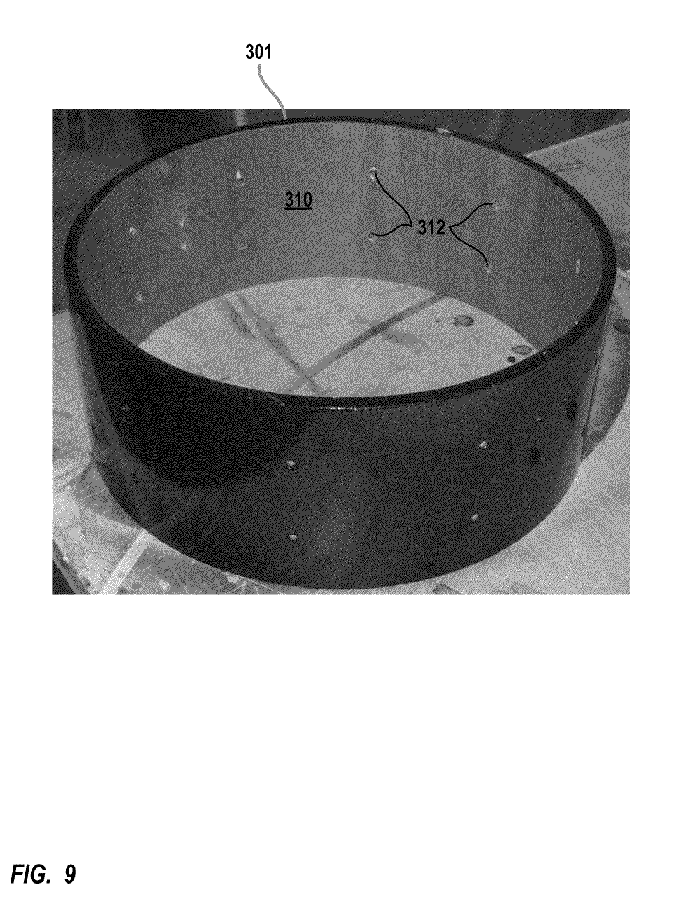

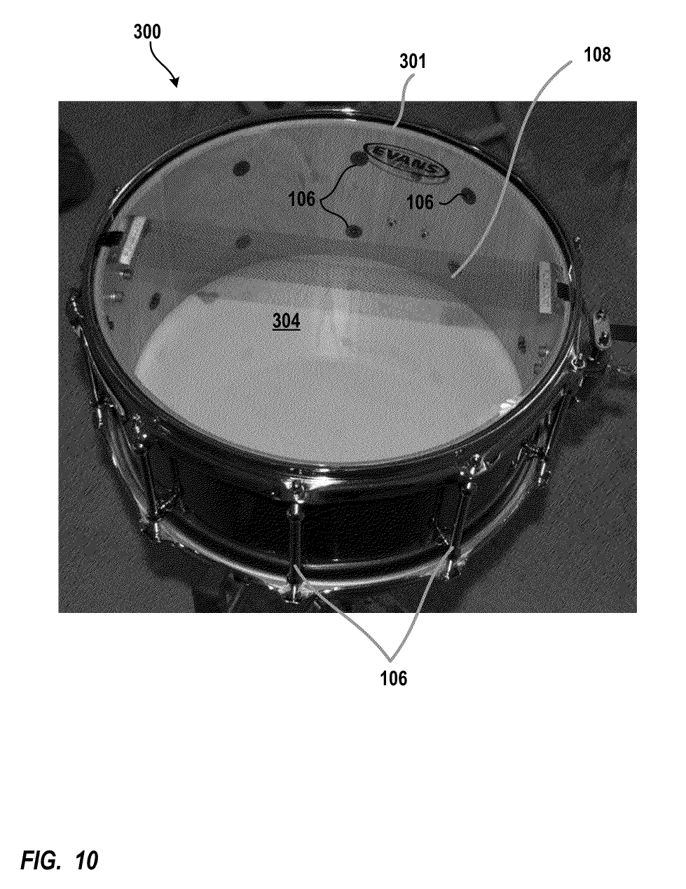

Referring to FIGS. 9-11, one embodiment of a hybrid drum shell 301 in accordance with the present disclosure includes bore holes 312 for attachment of the drum hardware 106. As shown in FIG. 9, the interior of the hybrid drum shell 301 appears uniform and reflects the material of the individual drum shell supplements 310. As shown in FIG. 10, the drum 300 using the hybrid drum shell 301 may include a drum head 304 and hardware 106 attached to the drum 300 in a manner similar to that described above and generally known to those skilled in the art. In one embodiment the drum 300 includes a snare 108.

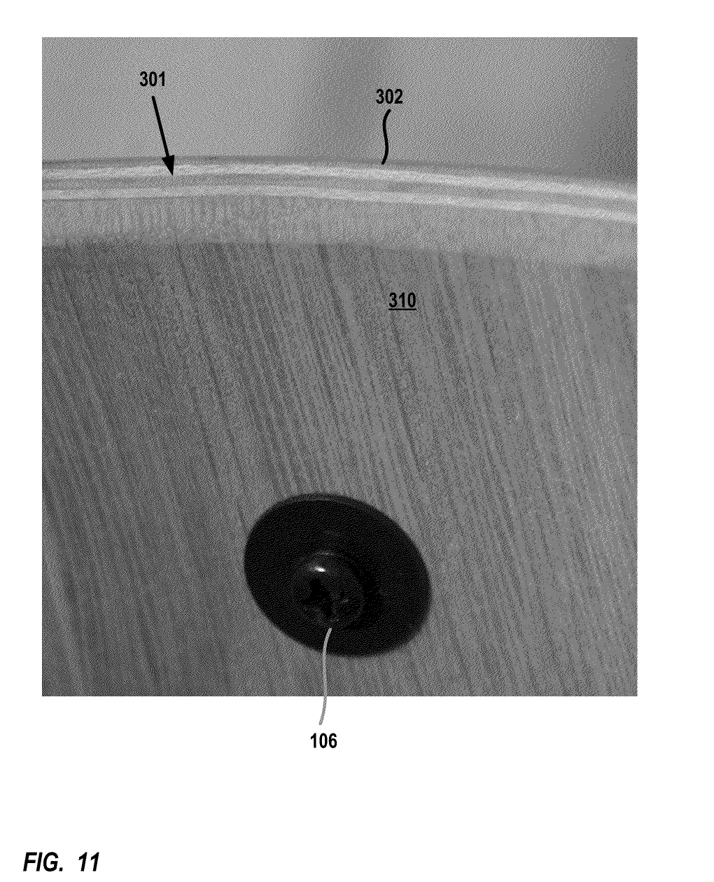

Referring to FIG. 11, an edge of the drum formed by the drum shell 302 and a drum shell supplement 310 of the hybrid drum shell 301 is shown. In one embodiment, there is little, substantially no, or no gap between the drum shell 302 and the drum shell supplement 310. In addition, the edges of the drum shell supplement 310 and the drum shell 302 may be sanded to provide a more uniform, smooth edge of the entire hybrid drum shell 301.

In alternate embodiments, the drum shell supplements 310 may be attached to the drum shell 302 in a variety of orientations. In one embodiment, the drum shell supplements 310 are attached such that the grain of the drum shell supplements 310 is aligned vertically with respect to the cylindrical axis of the drum shell 302. In alternate embodiments, the drum shell supplements 310 may be attached with the grain aligned horizontally (e.g., circumferentially) with respect to the drum shell 302. In yet other embodiments, the grain of the drum shell supplements 310 is aligned at acute or obtuse angles (e.g., diagonally) with respect to the drum 300. In one embodiment, the drum shell supplements 310 may be made of a sufficient circumferential width so as to limit the number of joints where two separate drum shell supplements 310 are connected. Such methodology decreases the amount of glue present in the resonant chamber, such that the resonant chamber has less tonal degradation caused by glue present in the resonant chamber (e.g., as with stave drum shells). In yet another embodiment, the hybrid drum shell 301 is formed using a single drum shell supplement 310 that is large enough to cover the entire interior circumference of the drum shell 302.

In one embodiment, the drum shell 302 is larger in height than the desired completed hybrid drum shell. In this embodiment, the drum shell supplements 310 are cut to the height of the drum shell 302. The drum shell supplements 310 are then attached to the drum shell 302 prior to cutting the drum shell 302 to the desired completed height (i.e., that of the drum 300) and sanding the edges.

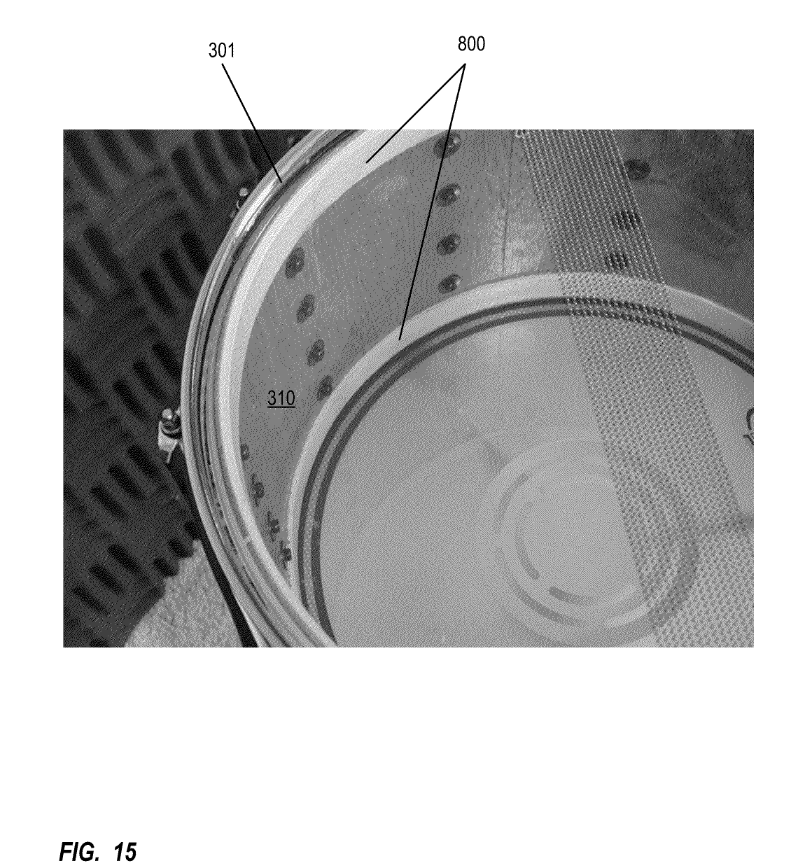

FIG. 15 depicts an embodiment of the hybrid drum shell 301 having reinforcement rings 800. In one embodiment, the reinforcement rings 800 may be a solid, cylindrical piece of material sized to fit around the interior circumference of the hybrid drum shell 301 (i.e., on top of the drum shell supplements 310). The reinforcement rings 800 are generally thinner than the hybrid drum shell 301 and may be made of any species of wood or other substance typically used in drum making The reinforcement rings 800 may be affixed to the hybrid drum shell 301 using an adhesive or any other method generally known in the art. In one embodiment, the drum shell 302 is constructed such that narrow cylindrical portions are removed from the drum shell 302. The removed cylindrical portions can be modified and used as reinforcement rings 800. Reinforcement rings 800 may help with the consistency of the sound and tuning of the hybrid drum shell 301. Although of FIG. 15 depicts the use of two reinforcement rings 800, it should be understood that other embodiments having a greater or fewer number of reinforcement rings 800 may be used. In addition, those skilled in the art will recognize that the height of the individual reinforcement rings 800 may differ from each other within a single hybrid drum shell 301 or between drums depending on the tonal qualities desired.

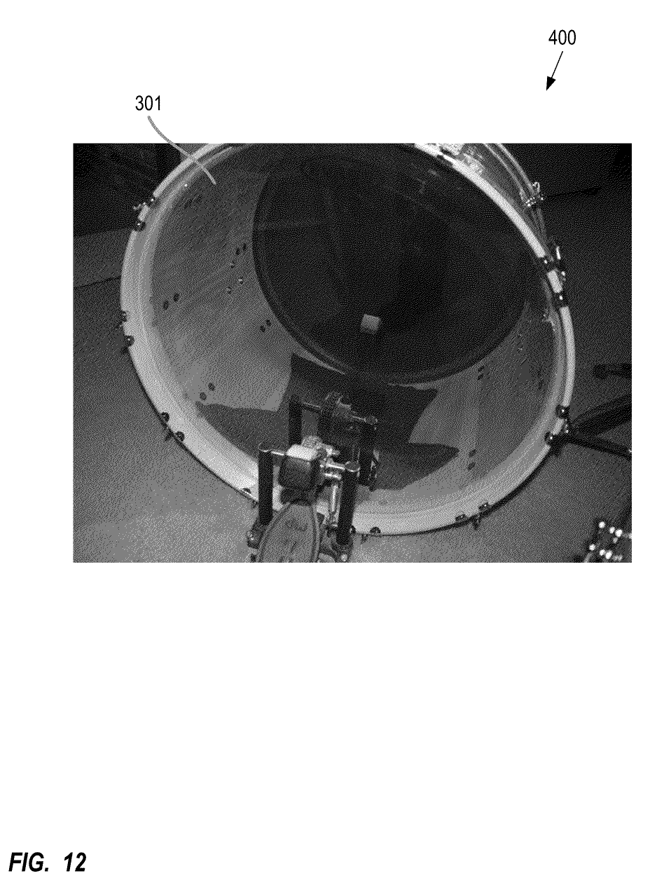

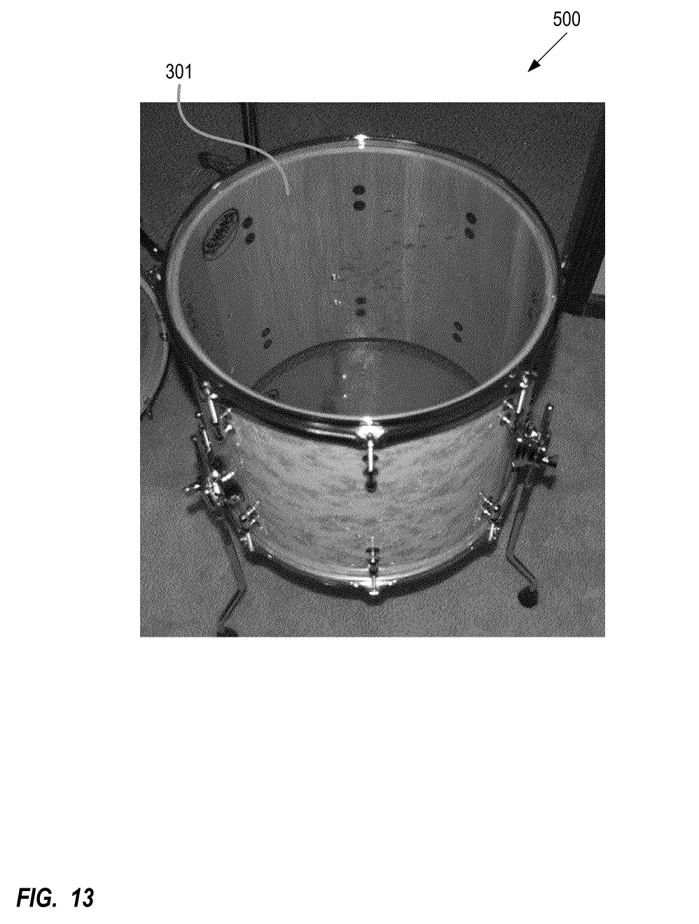

It should be noted that no one particular type of drum shell, drum shell material or drum is necessary for the subject matter of the present disclosure to be realized. Although FIGS. 3-11 show (and the present disclosure has been generally described with respect to) a snare drum and a snare drum shell, any type of drum may be made in accordance with the methodology, materials and processes described herein. For example, in FIGS. 12 and 13, a bass drum 400 and a tom-tom drum 500, respectively, are each made with a hybrid drum shell 301 in accordance with the methodology and materials described herein. In alternate embodiments, a metal drum may be used with metal, wood or other materials affixed in the same manner as described above.

In an alternate embodiment, a relatively thin stave style drum shell is created. The relatively thin stave style drum shell is then sized so the outer diameter is the same as the inner diameter of an original drum shell. The stave style drum shell is then affixed to the inner wall of the original drum shell. In yet another embodiment, the drum shell supplements 310 can be replaced with a single steam bent drum shell supplement. The single steam bent drum shell supplement would then be affixed to the interior of the original drum shells.

While specific embodiments have been described in detail in the foregoing detailed description and illustrated in the accompanying drawings, it will be appreciated by those skilled in the art that various modifications and alternatives to those details could be developed in light of the overall teachings of the disclosure and the broad inventive concepts thereof. It is understood, therefore, that the scope of the present disclosure is not limited to the particular examples and implementations disclosed herein, but is intended to cover modifications within the spirit and scope thereof as defined by the appended claims and any and all equivalents thereof.

I/we claim:

1. A hybrid drum shell comprising:
a drum shell made from at least one first species of wood; and
a plurality of drum shell supplements made from at least one second species of wood affixed to an interior side of the drum shell, wherein the drum shell supplements substantially conform to the curvature of the interior of the drum shell and are interconnected such that the drum shell supplements substantially cover the interior side of the drum shell.

2. The hybrid drum shell of claim 1, further comprising:
at least two reinforcement rings, wherein a first reinforcement ring is affixed to an upper portion of the interior side of the hybrid drum shell and a second reinforcement ring is affixed to a bottom portion of the interior side of the hybrid drum shell.

3. The hybrid drum shell of claim 1, wherein the at least one second species of wood is harder than the at least one first species of wood.

4. The hybrid drum shell of claim 1, wherein there is substantially no gap between any two adjoining drum shell supplements.

5. The hybrid drum shell of claim 1, wherein the drum shell is a ply drum shell.

6. The hybrid drum shell of claim 1, wherein the drum shell supplements are formed from generally rectangular pieces of wood having a length and width that are each greater than their thickness.

7. A method of making a hybrid drum shell, the method comprising:
(a) producing a plurality of drum shell supplements from at least one first species of wood, wherein the drum shell supplements have a length and width that are each greater than their thickness;
(b) bending the drum shell supplements to substantially conform to the curvature of an interior side of a drum shell made from at least one second species of wood; and
(c) affixing the plurality of drum shell supplements to the interior side of the drum shell, wherein the plurality of drum shell supplements are interconnected such that the affixed drum shell supplements substantially cover the interior side of the drum shell.

8. The method of claim 7, further comprising:
(d) applying a sealer to the interior of the hybrid drum shell after the affixing.

9. The method of claim 7, further comprising:
(d) affixing at least one reinforcement ring to the interior of the hybrid drum shell.

10. The method of claim 9, wherein one of the reinforcement rings is affixed to an upper portion of the interior of the hybrid drum shell and one of the reinforcement rings is affixed to a lower portion of the interior of the hybrid drum shell.

11. The method of claim 7, wherein producing the drum shell supplements comprises cutting thin, generally rectangular pieces from the at least one first species of wood, the at least one first species of wood being harder than the at least one second species of wood.

12. The method of claim 7, wherein the bending the drum shell supplements comprises securing the drum shell supplements against the interior side of the drum shell using a curved clamping block until the plurality of drum shell supplements substantially conform to the curvature of the interior side of the drum shell.

13. The method of claim 7, wherein the affixing the drum shell supplement to the interior side of the drum shell comprises:
i) coating the interior side of the drum shell with an adhesive;
ii) placing the drum shell supplements on the adhesive, such that the drum shell supplements are interconnected; and
iii) securing the drum shell supplements to the drum shell via a curved clamping block.

14. The method of claim 7, wherein the affixing the drum shell supplements results in substantially no gap between any two adjoining drum shell supplements.

15. The method of claim 7, wherein the drum shell supplements have angled or beveled lateral edges to facilitate affixing the drum shell supplements in an interconnected manner.

16. The method of claim 7, wherein the drum shell is a ply drum shell.

17. A hybrid drum comprising:
a generally cylindrical hybrid drum shell having a top and bottom, the hybrid drum comprising:
a drum shell made from at least one first species of wood, and
a plurality of drum shell supplements made from at least one second species of wood, the drum shell supplements affixed to an interior side of the drum shell, wherein the drum shell supplements substantially conform to the curvature of the interior of the drum shell and are interconnected such that the drum shell supplements substantially cover the interior side of the drum shell;
drum hardware;
a first drum head attached to the top of the generally cylindrical hybrid drum shell with the drum hardware; and
a second drum head attached to the bottom of the generally cylindrical hybrid drum shell with the drum hardware.

18. The hybrid drum of claim 17, wherein the generally cylindrical hybrid drum shell further comprises:
two reinforcement rings, wherein a first reinforcement ring is affixed to the an upper portion of the interior side of the hybrid drum shell and a second reinforcement ring is affixed to a bottom portion of the interior side of the hybrid drum shell.

19. The hybrid drum of claim 17, wherein the at least one second species of wood is harder than the at least one first species of wood.

20. The hybrid drum of claim 17, wherein the drum shell is a ply drum shell.
